(19) United States
(12) Patent Application Publication
(10) Pub. No.: US 2008/0005040 A1
(43) Pub. Date: Jan. 3, 2008

(54) Real estate transaction method

(76) Inventor: Michael J. Petersen, Dana Point, CA (US)

Correspondence Address: STETINA BRUNDA GARRED & BRUCKER, 75 ENTERPRISE, SUITE 250, ALISO VIEJO, CA, 92656, US

(21) Appl. No.: 11/476,267

(22) Filed: Jun. 28, 2006

(51) Int. Cl. G06Q 40/00

(52) U.S. Cl. 705/36 T

(57) ABSTRACT

Real estate transaction methods are disclosed to allow holders of tenancy in common (TIC) property interests to convert such interests to real estate investment trusts (REIT) holdings. Such methods comprise a conversion of TIC property interests to REIT status through an UPREIT process, a DOWNREIT process and a process to accommodate a 1031 Exchange whereby at some point in the future a TIC interest is converted to REIT holdings through either an UPREIT or DOWNREIT transfer.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to methods for facilitating real estate transactions, and more particularly, methods for facilitating transactions of real estate held as a tenancy in common and Real Estate Investment Trusts commonly known as REITs.

As is well-known, title to real estate may be held as a tenancy in common (TIC). In a TIC, two or more persons each own a separate undivided interest in the real property and each tenant has rights in the whole of the property. As such, each separate undivided interest may be sold, gifted, pledged as collateral, etc. A TIC is a common means for two people to own commercial real estate, who will share in the management and participate in the economics associated with the property, including overseeing all tax aspects of the ownership in proportion to their respective interests as TIC

Because a TIC interest is an interest in real property, such property interest can be exchanged into or out of as part of a tax deferred like kind exchange, known to those familiar with the United States tax code as a 1031 Exchange. Essentially, this section allows people to defer gain on property held for investment or trade or business provided that they re-invest in “like kind” property. The process essentially creates a carry over of the existing tax status and basis of the sold property to the “like kind” property for which it is exchanged.

1031 Exchanges became much more practical with the adoption of the so called “Stockhard Exchange,” which essentially allows a third party intermediary to receive and hold the cash proceeds of the sale of real property, and then reinvest the proceeds in “like kind” property. Because the principal has not received the sale funds, the principal is deemed not to have received income. The principal has 45 days to designate one or more replacement properties and 180 days in which to close on one or more of the designated properties. If all funds are not reinvested, the investor is taxed on the proceeds and, to the extent only a portion of the proceeds are re-invested, the un-reinvested portion is proportionately taxed as such. There are a variety of rules and regulations regarding relief from indebtedness and related matters, which would be readily understood by one skilled in the art.

A 1031 Exchange is very commonly used by commercial property investors and probably accounts for close to half of the commercial property sales. Many companies are engaged in the business of serving as 1031 facilitators. As a major consideration, it is important to note that when commercial property has been held for a number of years, between depreciation, etc., it is common for the adjusted basis of the property to be less than the outstanding loan balances against the property. When the property has substantially appreciated and the owner has withdrawn some of that appreciation in the form of loans, the taxes due upon the sale of a commercial property can easily exceed the total amount received by the owner for the property. This is a fact that makes 1031 a practical necessity to long-term property holders.

As discussed above, a TIC interest is an interest that can be exchanged into or out of as part of a tax deferred like kind exchange under 1031. For example, a husband and wife could own a 4 unit apartment building and exchange into a one-tenth Tenant in Common interest in an office building on a tax deferred basis. However, from a practical standpoint, the nature of the investment is quite different. The office building is almost certainly professionally managed and requires little or no involvement in the day-to-day operations by the Tenants in Common, unlike the 4 unit building exchanged.

The ability to do tax deferred exchanges, which significantly alter the property type and responsibilities of ownership, has given raise TIC promoters. These promoters range from the small “mom and pop” organization where a few close friends to convert their holding to large scale TIC Promoters, who typical take larger properties, break them into 100 units of TIC and sell to up to 35 investors through a network of licensed broker dealers as a security to qualified investors giving the required disclosure through a private placement memorandum (commonly called a PPM). Such large TIC arrangements typically include a TIC Agreement which regulates the relationship of the individual TIC holders, as well as Asset Management Agreements (generally with the prompter for purposes of maintaining and securing financing, soliciting sales of the property and other financial management services) and Property Management Agreements (generally with an affiliate of the promoter to lease the property (pursuant to established criteria) and to arrange maintenance collect funds and pay bills.) The establishment of the large TIC was made easier by the issuance of Rev Pro 2003-3 issued in 2003 substantially clarified the rules for TIC agreements to avoid classification as a partnership. Among other things, these rules require that the TIC Agreement unanimous decision making on a number of key issues including sale of the property; however, a provision allowing an option to purchase dissenting TIC holders is permissible.

While large TIC arrangements allow tax deferred exchanges into different types of property, they have substantial disadvantages. The investment is in a single property, which generally means there is no diversification. Ownership units are large, generally $100,000 per Tenancy in Common unit, and are not subdivided into smaller holdings, which thus limits the holder's ability to gift portions of his or her holding or engage in certain types of estate planning.

Most significantly, there is presently no existing secondary market for the sale of separate TIC interests, nor is there an existing separate market ability to finance separate TIC interests While legally a TIC could give a Deed of Trust pledging his TIC interest as security for a loan, there is presently no commercial entity actively engaged in this practice. This means that there is no liquidity or exit plan for the TIC unit holders other than a sale of the entire property, which, as a practical matter, is not under the control of the TIC unit holder. In fact the commercial reality is that the Promoter controls the sales process, which may or may not occur at a desirable time for specific unit holders. The sale is a tax recognition event, which as discussed above can have extremely negative consequences for the TIC holder. While the TIC holder can in theory avoid gain recognition by another 1031 exchange, such an exchange opportunity may not be available in the market place within the required time frames.

In contrast to the extremely limited market for the sale of separate TIC interests and means to finance separate TIC interests, are real estates investment trusts (REIT). REITs are corporations provided with a tax designation that invest in real estate for purposes of reducing or eliminating corporate income taxes. In this regard, the REIT structure is designed to provide a similar structure for investment in real estate as mutual funds provide for investment in stocks. REITs can be publicly or privately held and public REITs may be listed on public stock exchanges, similar to shares of common stock and other corporations, and currently there are approximately 190 publicly traded REITs. Generally, REITs in the United States pay little or no federal income tax, but are subject to a number of special requirements set forth in the tax code, including the requirement to annually distribute at least ninety percent of its taxable income in the form of dividends to its shareholders.

With respect to its acquisition of real property, there are four (4) essential means by which a REIT can achieve that end. First, a REIT can acquire real property through a direct purchase for cash. Secondly, a REIT can acquire real property via a contribution of the real property in exchange for REIT shares. Third and fourth, discussed more fully below, REITs may acquire real property via processes called UPREIT and a DOWNREIT, respectively.

In the context of a standard cash purchase, when a REIT purchases property for cash, a seller has the opportunity to buy “like kind” property and defer gain. However, REIT shares are by definition not “like kind” so the seller cannot defer taxes by investing in a REIT. The seller could elect a 1031 exchange in selling to a REIT just as with any other sale transaction.

According to the second means, the REIT can simply exchange REIT shares for the Property. While IRS Code Section 351 does provide that no gain or loss is recognized if property is transferred to a corporation in exchange for that corporations stock, this does not apply to a real property transfer to a REIT. In that regard, IRS Code Section 351 (e) specific excludes transfers to a REIT.

With respect to the third process by which a REIT may acquire real estate, namely via an UPREIT, the same typically occurs when a newly formed REIT will transfer cash raised in an initial public offering to an operating partnership (OP) in exchange for a general partnership interest in the OP. The OP in turn will contribute cash to the existing target acquisition partnerships (EP), which own real property. The partners of the EP will then contribute their partnership interest in the EP to the OP, in return for limited partnership interests in the OP, typically through Limited OP Partnership Units. This exchange receives non-recognition under Section 721, insofar as the OP is not a REIT or an investment company, hence avoiding the 351 (e) exception.

The Limited OP Partnership Units (“LOPU”) are convertible into REIT shares (usually after some agreed-upon period of time), which creates market liquidity. The conversion of LOPU into REIT shares is a recognition event triggering gain on those shares. Generally each LOPU are set up to mimic one REIT share, and get distributions through the OP equal to the each share of REIT stock. Additionally, preferred LOPU may be created that have the common characteristics of preferred stock such as preference on liquidation and fixed return. This is done to meet the desires of holders of the EP for more fixed returns. LOPU, while generally not publicly traded, may be transferred for estate planning purposes or charitable donations without triggering the realization of gain. Additionally, a market is developing in loans secured by a pledge of LOPU (similar to a stock margin loan). From a very practical standpoint, those skilled in the art will readily appreciate that the ability to issue preferred type shares may allow more flexibility such that an LOPU may more accurately meet the financial needs of the investor say for a fixed return.

In addition to the conversion of the LOPU triggering gain recognition, so does the sale by the OP of the contributed property. Typically the OP agrees by contract to hold the property for a period of time, ranging from 5 to 20 years. However, it may be possible for the REIT to still sell the property provided it does so via a 1031 exchange. While a 1031 requirement may seem to limit the REIT's options, as a practical matter a REIT is in the business of owning real property so a 1031 limitation has little or no practical impact.

Under IRS Regulations section 1.856-3(g) the so called “look through rules” the REIT looks through the OP for purposes of applying the income and asset tests applicable to REIT's and includes its assets as part of the REIT for tax/accounting purposes. Look through rules have been applied by the IRS to multiple levels of partnerships.

The fourth process, namely a DOWNREIT, is typically utilized to acquire real property after the REIT has been established. It essentially allows an existing REIT to acquire real estate in the same manner as an UPREIT. In the DOWNREIT context, the REIT forms an operating partnership (“OP”) to which the REIT contributes cash and REIT shares. The property owners contribute real property to the OP in consideration for LOPU, which carry conversion rights as above discussed. While the contributed property is held separately by the OP, generally through contract and preference payments the LOPU holders obtain a return which is the same as holders of REIT shares.

The biggest distinction between the UPREIT and the DOWNREIT is the use of existing REIT shares verses an initial offering. In the marketplace, the UPREIT is generally a transaction structured around an initial REIT offering allowing the holders of substantial commercial property a tax advantaged mechanism to take the property to the REIT public markets as was the case in the Taubman offering. The DOWNREIT is a variation on that transaction using an existing REIT and generally one-off deals for specific properties. In the UPREIT there is usually one large OP. In the DOWNREIT typically one would see a number of individually structured OP's for specific property with specific contributors. Similar opportunities exist for preferred LOPU in both structures.

In view of the foregoing, it is apparent that the REIT structure offers a tremendous advantage of enabling investors to invest in real estate via market mechanisms and structures similar to acquiring shares in a corporation. Large TICs, on the other hand, are extremely limited and their liquidity can often times become undesirable due to the lack of ability of the holder of the TIC interest to liquidate or otherwise conduct transactions as can individuals participating in REITs. Accordingly, there is a substantial need in the art for methods that can enable holders of TIC interests to engage in transactions similar to those afforded to REITs. There is a further need for such methods that can be standardized in nature, well-regulated, and provide substantial benefits to TIC holders that are currently not afforded to them.

### BRIEF SUMMARY

The present invention specifically addresses and alleviates the above-identified deficiencies in the art. In this regard, the present invention is directed to bringing UPREIT and DOWNREIT type transactions to TIC property holders. Generally, as a practical matter this will occur in concert with TIC promoters, and allow the TIC unit holders to convert their TIC units into LOPU, which have the investment affect of diversifying their holdings and thereby reducing the risks involved, providing true professional management, greater flexibility of the LOPU.

There are 3 essential types of transactions through which this will be achieved:

TIC conversion to REIT status, where property(ies) held in TIC ownership are converted through an UPREIT process to a REIT type holding. This essentially would be a way for a TIC Promoter to create their own REIT and combine a number of the TIC properties into a new REIT without creating a tax realization event.

In the second transaction, a REIT acquires property held in TIC ownership through a DOWNREIT. These transactions would most likely occur when an existing REIT seeks to acquire property held in TIC form on a specific property-by-property basis. This would be particularly attractive for larger well-regarded public REITs as an acquisition method.

In a third transaction, an integrated step transaction is provided in which when the TIC is initially established to accommodate the 1031 exchange and a program is established to at a future point in time convert the holding to a REIT holdings through an UPREIT or DOWNREIT transfer. Consideration would have to be given to avoid a step transaction (IRS combining the transfers into one for tax purposes) and will generally involve at least 2 year holding periods and valuations at the time of transfers.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a flow chart showing the steps of making a TIC conversion to REIT status through an UPREIT process as contemplated by the present invention.

FIG. 2 depicts a flow chart showing the steps of making a TIC conversion to REIT status through a DOWNREIT process as contemplated by the present invention.

FIG. 3 depicts a flow chart showing the steps of a transaction in which the TIC, initially established to accommodate a 1031 Exchange is thereafter integrated as part of a program established at some future point in time to convert a holding to a REIT holding through either an UPREIT or a DOWNREIT transfer.

### DETAILED DESCRIPTION

The above description is given by way of example, and not limitation. Given the above disclosure, one skilled in the art could devise variations that are within the scope and spirit of the invention disclosed herein, including various ways of facilitating real estate transactions held as a TIC, especially through REIT-type transactions. Further, the various features of the embodiments disclosed herein can be used alone, or in varying combinations with each other and are not intended to be limited to the specific combination described herein. Thus, the scope of the claims is not to be limited by the illustrated embodiments.

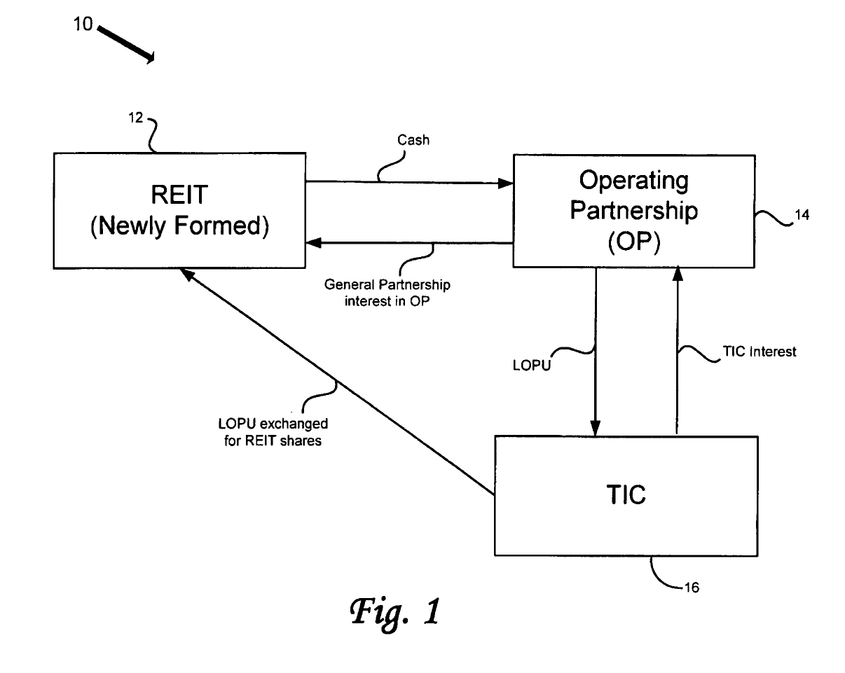

Referring now to the figures and initially to FIG. 1, there is shown a method 10 for facilitating the conversion of a TIC real property interest to REIT status as contemplated by the present invention. Specifically, FIG. 1 depicts such conversion being made through an UPREIT-type process 10. According to such method 10, there will be provided a newly formed REIT 12 which will be established via conventional means, such as through an initial public offering and the like. Concurrent with the formation of the REIT 12 will be the formation of an Operating Partnership (OP) 14. Per conventional REIT-type transactions, the REIT 12 will most likely provide cash to the OP 14 in return for a general partnership interest in OP 14.

To acquire a real property interest, and in particular real estate held as a TIC 16, the OP 14 will engage in a separate transaction whereby Limited OP Partnership Units (LOPU) will be exchanged for a TIC interest. Advantageously, such transaction thus enables the holders of TIC interests with means to convert a TIC interest for a specific type of instrument, and in particular LOPU. Thereafter, per conventional REIT-type transactions, the former holder of TIC interest 16 can exchange the LOPU for REIT shares.

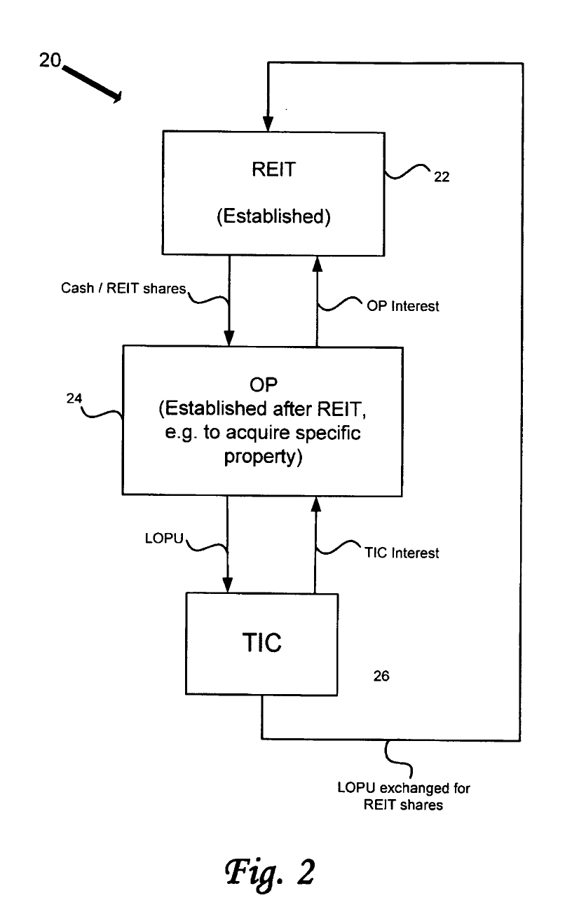

Referring now to FIG. 2, there is shown a DOWNREIT-type transaction by which property held as a TIC and/or a TIC interest can be converted to marketable REIT shares. As illustrated, the process 20 centers around an established REIT 22, as opposed to a newly formed REIT 12 depicted in FIG. 1. Per conventional practices, the established REIT 22 will create a separate OP 24 and, per conventional REIT practice, will typically involve the creation of an OP 24 designed for the acquisition for a specific property, which in this case will involve property held as a TIC. The established REIT 22 and OP 24 will engage in a transaction whereby cash and/or REIT shares are exchanged for an OP interest. Thereafter, the OP 24 will enter into a transaction with the TIC and all the property owners whereby the latter's interest will be exchanged for LOPU. The LOPU may then be converted by the TIC interest holder 26 for REIT shares per conventional transactions known in the art. Accordingly, FIG. 2 represents a process 20 whereby the DOWNREIT-type transaction may be readily applied to facilitate the liquidity of a TIC interest.

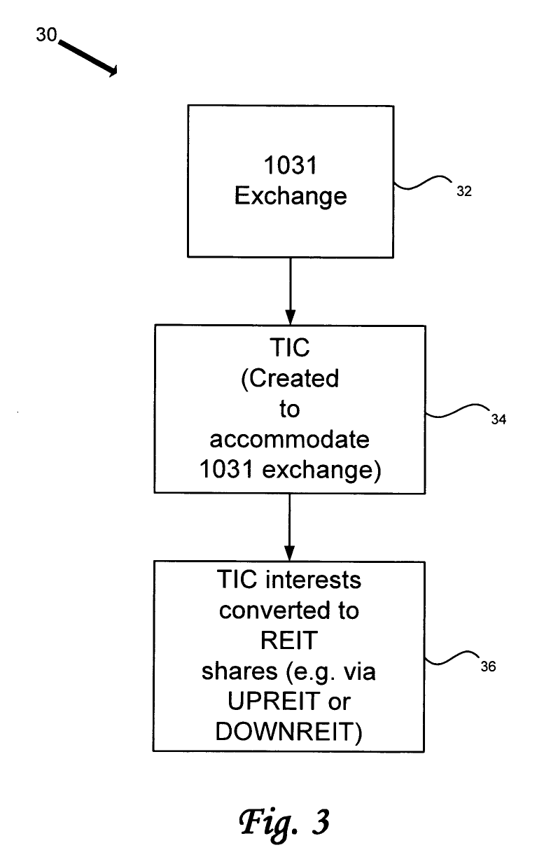

Referring now to FIG. 3, there is shown a generalized process 30 which may be deployed to facilitate the ability of a property held as a TIC to be integrated as part of a 1031 Exchange 32 and thereafter later integrated as part of a standardized REIT-type transaction to thus ultimately provided the holder of the TIC interest with means to ultimately liquidate that interest in known, established financial markets and transactions. As illustrated, the process 30 essentially involves a standard 1031 Property Exchange 32 which involves the property held as a TIC 34. In this regard, such transaction merely involves a like kind exchange of property that merely involves property held as a TIC, as is known and accepted practice.

Once having been exchanged as part of a 1031 Exchange, the TIC-held property 34 may thereafter ultimately have the TIC interests converted to REIT shares via those processes discussed above in relation to FIG. 1 and FIG. 2, namely, through either an UPREIT or DOWNREIT transfer. As will be understood, in such process 30, consideration will have to be given to avoid the step transaction and, as presently believed, will generally involve at least a two year holding period at valuations at the time of transfers. Nevertheless, processes depicted in FIG. 3 shows yet another way how a property held as a TIC may not only be utilized as part of a 1031 Exchange, but may also ultimately become integrated in a transaction involving either an UPREIT or DOWNREIT transaction that ultimately provides liquidity for the holder of the TIC interest.

As a consequence, property held as a TIC can thus be integrated within the currently-existing framework by which REITs can own and make other transactions related to real estate. Along these lines, it is believed that such transaction will advantageously allow real estate held as a TIC, and in particular those types of properties with multiple tenants, to liquidate their interests without being constrained by existing TIC arrangements, and in particular large TIC arrangements that include over ten investors. Along these lines, it is believed that the transactions of the present invention will be well suited for TIC arrangements for any number of TIC interests, but will be extremely well suited for properties held from between 8 to 35 tenant in common interests. Along these lines, it is considered especially advantageous for TIC-held properties having between 15 to 35 TIC interests, and more highly preferred for properties having from 20-35 TIC interests, and in the most highly preferred applications TICs having from 25-35 and 30-35 TIC interests.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention. Along these lines, it will be well understood that the transactions discussed herein may be applicable for virtually all types of REITs, whether publicly or privately held, and may involve an ultimate exchange of TIC interests for preferred LOPU or any other type of instrument that may be convertible to other instruments and the like.

What is claimed is:

1. A method for facilitating the liquidity of a TIC property interest comprising the steps:
a. creating a REIT;
b. creating an operating partnership associated with the REIT;
c. engaging in a transaction whereby cash from the REIT is exchanged for a partnership interest in the operating partnership;
d. providing a TIC property interest;
e. exchanging the TIC interest for at least one limited operating partnership unit of the operating partnership; and
e. converting the limited operating partnership unit obtained from the exchange with the TIC interest for shares of the REIT provided in step (a).

2. The method of claim 1 wherein in step (a), said newly formed REIT is formed by means of an initial public offering.

3. The method of claim 1 wherein in steps (d) and (e), said TIC interest is at least one of up to 35 TIC interests in said real property.

4. The method of claim 3 wherein in steps (d) and (e), said TIC interest is at least one of up to 30 TIC interests in said real property

5. The method of claim 3 wherein in steps (d) and (e), said TIC interest is at least one of up to 25 TIC interests in said real property.

6. The method of claim 3 wherein in steps (d) and (e), said TIC interest is at least one of up to 20 TIC interests in said real property.

7. The method of claim 3 wherein in steps (d) and (e), said TIC interest is at least one of up to 15 TIC interests in said real property.

8. The method of claim 3 wherein in steps (d) and (e), said TIC interest is at least one of up to 10 TIC interests in said real property.

9. A method for facilitating the liquidity of a TIC property interest comprising the steps:
a. providing an existing REIT;
b. creating an operating partnership associated with the REIT;
c. engaging in a transaction whereby cash from the REIT is exchanged for a partnership interest in the operating partnership;
d. providing a TIC property interest;
e. exchanging the TIC interest for at least one limited operating partnership of the operating partnership; and
f. converting the limited operating partnership unit obtained from the exchange with the TIC interest for shares of the REIT provided in step (a).

10. The method of claim 9 wherein in steps (d) and (e), said TIC interest is at least one of up to 35 TIC interests in said real property.

11. The method of claim 9 wherein in steps (d) and (e), said TIC interest is at least one of up to 30 TIC interests in said real property

12. The method of claim 9 wherein in steps (d) and (e), said TIC interest is at least one of up to 25 TIC interests in said real property.

13. The method of claim 9 wherein in steps (d) and (e), said TIC interest is at least one of up to 20 TIC interests in said real property.

14. The method of claim 9 wherein in steps (d) and (e), said TIC interest is at least one of up to 15 TIC interests in said real property.

15. The method of claim 9 wherein in steps (d) and (e), said TIC interest is at least one of up to 10 TIC interests in said real property.

16. A method of converting a TIC property interest to a liquidatable REIT share comprising the steps:
a. providing a first real estate interest held as a TIC;
b. exchanging said property provided in step (a) pursuant to a 1031 Exchange;
c. acquiring said property exchanged in step (b) previously held as a TIC in step (a) by a REIT; and
d. providing shares of said REIT to at least one holder of the TIC interest of said real estate provided in step (a).

17. The method of claim 16 wherein said REIT shares provided to said TIC interest holder in step (d) are provided via an UPREIT-type transaction.

18. The method of claim 16 wherein said REIT shares provided to said TIC interest holder in step (d) are provided via a DOWNREIT-type transaction.
